(19) United States
(12) Patent Application Publication
(10) Pub. No.: US 2026/0001593 A1
(43) Pub. Date: Jan. 1, 2026

(54) VIBRATION DAMPING STRUCTURE

(71) Applicants: MAZDA MOTOR CORPORATION, Hiroshima (JP); NIHON TOKUSHU TORYO CO., LTD., Tokyo (JP)

(72) Inventors: Hiroyuki NAGATOMO, Hiroshima (JP); Ryuji NONAKA, Hiroshima (JP); Yuji MIYOSHI, Hiroshima (JP); Shinichi OHSHIMA, Hiroshima (JP); Hiroyuki HIRAO, Hiroshima (JP); Akira HOTTA, Hiroshima (JP)

(73) Assignees: MAZDA MOTOR CORPORATION, Hiroshima (JP); NIHON TOKUSHU TORYO CO., LTD., Tokyo (JP)

(21) Appl. No.: 19/237,107

(22) Filed: Jun. 13, 2025

(30) Foreign Application Priority Data
Jun. 27, 2024 (JP) 2024-104299

(51) Int. Cl. B62D 25/20; B62D 27/04

(52) U.S. Cl. CPC B62D 25/2009; B62D 27/04

(57) ABSTRACT

A vibration damping structure includes a panel member, a vibration damper, and a restriction layer. The vibration damper has a plurality of protruding parts each extending continuously along a first direction being a direction in which the vibration damper is to be stretched or compressed in response to application of a bending load to the panel member, and spaced away from each other in a second direction orthogonal to the first direction, and a plurality of recessed parts each formed between two protruding parts adjacent to each other among the protruding parts. The restriction layer fits in the recessed parts.

### FIELD OF INVENTION

The present invention relates to a vibration damping structure for a panel member such as a floor panel of a vehicle.

### BACKGROUND ART

There have been various structures proposed to reduce vibration of a floor panel that constitutes a floor of a vehicle during running of the vehicle. For example, as disclosed in Japanese Unexamined Patent Publication No. 2006-315627, there has been known a structure in which a vibration damper made of, e.g., an asphalt-based resin capable of damping vibration is applied on a part of the floor panel which has a low rigidity and is easily vibrated.

In the structure including the vibration damper applied on the floor panel, the vibration damper converts vibration energy transmitted from a frame of a vehicle body to the floor panel during running of the vehicle into, e.g., heat energy, so that vibration of the floor panel is reduced. Consequently, ride quality and NVH performance, i.e., performance of reducing noise, vibration, and harshness (roughness or uncomfortableness), are improved.

It is indispensable for further enhancement of a vibration damping effect of the structure described above to increase an amount of the vibration damper; thus, there is room for improvement in the enhancement of the vibration damping effect for production cost and the weight of the vibration damper.

### SUMMARY OF THE INVENTION

The present invention has been made in view of the above-mentioned circumstances, and an object thereof is to provide a vibration damping structure that can enhance the vibration damping effect while preventing excessive increase in the vibration damper.

To solve the problem described above, a vibration damping structure of the present invention includes: a panel member; a vibration damper adhered to at least one surface of the panel member; and a restriction layer that is adhered to a surface of the opposite side of the vibration damper from the panel member, and is less deformable than the vibration damper. The vibration damper has a plurality of protruding parts each extending continuously along a first direction being a direction in which the vibration damper is to be stretched or compressed in response to application of a bending load to the panel member, and spaced away from each other in a second direction orthogonal to the first direction, and a plurality of recessed parts each formed between two protruding parts adjacent to each other among the protruding parts. The restriction layer fits in the recessed parts.

### BRIEF DESCRIPTION OF THE DRAWINGS

FIG. 1 is a perspective view of a whole vibration damping structure according to an embodiment of the present invention with a partial omission.

FIG. 2A is an illustration for describing shear deformation of a vibration damper in accordance with bending deformation of a panel member in FIG. 1 due to vibration, showing that no shear deformation occurs in a comparative example that does not include a restriction layer.

FIG. 2B is an illustration for describing shear deformation of the vibration damper in accordance with bending deformation of the panel member in FIG. 1 due to vibration, showing that shear deformation occurs in the embodiment due to restriction of the vibration damper by the restriction layer.

FIG. 3A is an illustration indicating distribution of strain energy stored in the vibration damper in accordance with bending deformation of the panel member in FIG. 1, showing that strain energy stored in the vibration damper is low in the comparative example that does not include the restriction layer.

FIG. 3B is an illustration indicating distribution of strain energy stored in the vibration damper in accordance with bending deformation of the panel member in FIG. 1, showing that strain energy stored in the vibration damper is high in the embodiment due to the restriction of the vibration damper by the restriction layer.

FIG. 4A is an illustration representing a storage process of strain energy at a corner of a protruding part and a corner of a recessed part of the vibration damper according to the embodiment in FIG. 1 in response to vibration, showing a state before the vibration.

FIG. 4B is an illustration representing the storage process of strain energy at the corner of the protruding part and the corner of the recessed part of the vibration damper according to the embodiment in FIG. 1 in response to vibration, showing a state during the vibration where the strain energy is stored at the corners.

FIG. 5 is a table showing exemplary vibration damping structures for examining a vibration damping effect, where I to III represent structures as examples, which have one, two, or three layers of the vibration damper and the restriction layer adhered to an uppermost layer of the vibration damper, and IV to VI represent structures as comparative examples, which have one, two, or three layers of the vibration damper only without the restriction layer.

FIG. 6 is an illustration schematically showing a test sample as an example in which the vibration damper is applied longitudinally on the panel member.

FIG. 7 is a graph showing a relationship between inertances and frequencies of vibration waves due to vibration to vibration damping structures in which the test sample as the example in FIG. 6 is combined with structures I to VI in FIG. 5, and vibration to a structure X including the panel member only.

FIG. 8 is an illustration schematically showing a structure as a comparative example in which the vibration damper is applied laterally on the panel member.

FIG. 9 is a graph showing a relationship between inertances and frequencies of vibration waves due to vibration to vibration damping structures in which the test sample as the comparative example in FIG. 8 is combined with the structures I to VI in FIG. 5, and vibration to the structure X including the panel member only.

FIG. 10 is an illustration schematically showing an application direction of the vibration damper according to the embodiment and two bending directions thereof.

FIG. 11 is a perspective view of a configuration in which the vibration damping structure according to the embodiment is used for a floor panel of a vehicle.

FIG. 12 is an enlarged perspective view of a configuration in which the vibration damping structure according to the embodiment is used for a spare tire pan as a curved part of the floor panel of the vehicle, showing that a plurality of vibration dampers extends radially.

FIG. 13 is an enlarged perspective view of a configuration in which the vibration damping structure according to the embodiment is used for a spare tire pan having an opening as the curved part of the floor panel of the vehicle.

FIG. 14 is an enlarged plan view of a plurality of vibration dampers extending radially from a ridgeline around the opening in FIG. 13.

### DETAILED DESCRIPTION

Hereinafter, a vibration damping structure according to an embodiment of the present invention will be described with reference to the accompanying drawings.

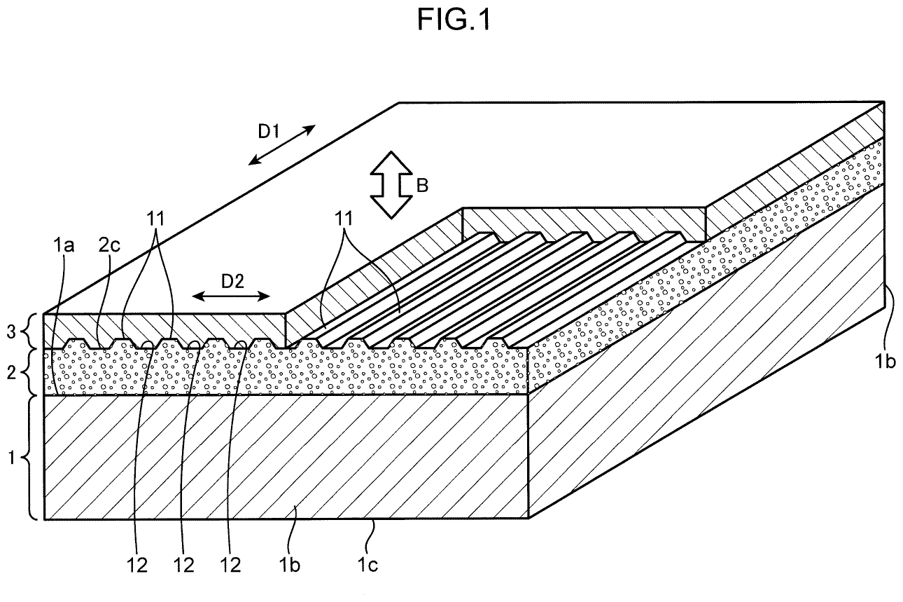

As shown in FIG. 1, the vibration damping structure according to the embodiment includes a panel member 1 in shape of a plate, a vibration damper 2 adhered by, e.g., application, to at least one surface of the panel member 1, in the embodiment, adhered to an upper surface 1a, and a restriction layer 3 adhered to a surface of the opposite side of the vibration damper 2 from the panel member 1, in the embodiment, adhered to an upper surface 2c. The vibration damping structure has a three-layered structure in which the panel member 1, the vibration damper 2, and the restriction layer 3 are layered one after another and connected with each other. The vibration damper 2 and the restriction layer 3 may be adhered to a lower surface 1c of the panel member 1, or may be adhered to both of the upper surface 1a and the lower surface 1c of the panel member 1.

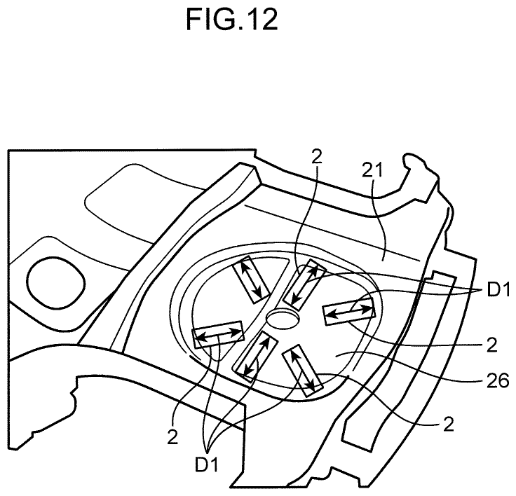

The panel member 1 is a plate member attached to a part to receive external vibration, and is used as, e.g., a floor panel 21 (see FIGS. 11 to 13) that constitutes a floor of a vehicle as described later. The panel member 1 is used with at least its opposite ends 1b being fixed, preferably, with its surrounding ends being fixed. The material of the panel member 1 is not particularly limited in the present invention. In a case where the panel member 1 is used as the floor panel 21 of the vehicle, the panel member 1 may be a thin steel plate.

The vibration damper 2 is adhered to the upper surface 1a of the panel member 1 by, e.g., application or pasting. The vibration damper 2 is made of material capable of damping vibration transmitted to the panel member 1. For example, material such as an acrylic emulsion paint is used; more specifically, material containing a foaming agent to foam by heating, such as the acrylic emulsion paint, a polyurethane resin paint, an epoxy resin paint, and a vinyl chloride plastisol paint, is used. The vibration damper 2 has a rigidity or an elasticity enough to exert the vibration damping effect; for example, the vibration damper 2 has a Young's modulus of approximately 400 MPa to 700 MPa. The acrylic emulsion paint described above has a Young's modulus of approximately 600 MPa.

As shown in FIG. 1, the vibration damper 2 in the embodiment is made of a resin to foam and cure superficially by heating, the resin being composed of the acrylic emulsion paint and applied in a certain first direction D1. Thus, the vibration damper 2 has a layer containing bubbles on the upper surface 1a of the panel member 1. The vibration damper 2, which contains the bubbles, stores vibration energy transmitted to the panel member 1 as strain energy to thereby damp the vibration of the panel member 1.

The vibration damper 2 has a plurality of protruding parts 11 and a plurality of recessed parts 12 over the upper surface 1a.

Each of the protruding parts 11 is continuous (extends) along a first direction D1 being a direction in which the vibration damper 2 is to be stretched or compressed in response to application of a bending load B to the panel member 1, specifically, in response to the application of the bending load B caused by external vibration to the panel member 1 with its opposite ends 1b being fixed. The protruding parts 11 are spaced away from each other in a second direction D2 orthogonal to the first direction D1.

Each of the recessed parts 12 is formed between two protruding parts 11 adjacent to each other.

The protruding parts 11 are formed during formation of the vibration damper 2 by: applying, e.g., the acrylic emulsion paint to be the vibration damper 2 on the upper surface 1a of the panel member 1 so as to extend in the first direction D1 while causing a plurality of nozzles to discharge the paint; and then heating the paint to cause the paint to foam and cure superficially. Thus, each of the protruding parts 11 extends continuously in the first direction D1 and has a substantially semicircular cross-section or a substantially rectangular cross-section. On the other hand, the recessed part 12 formed between the two protruding parts 11 adjacent to each other is a groove extending in the first direction D1 and having a shape conforming to opposite surfaces of the two protruding parts 11 adjacent to each other.

The restriction layer 3 is adhered by, e.g., application to a surface of the opposite side of the vibration damper 2 from the panel member 1, in the embodiment, adhered to the upper surface 2c.

The restriction layer 3 is made of material less deformable than the vibration damper 2, e.g., an acrylic resin used for clear coating of a surface of the vehicle body in vehicle manufacturing. The restriction layer 3 is less deformable (e.g., has a higher rigidity or a higher elasticity) than the vibration damper 2; for example, the restriction layer 3 has a Young's modulus of approximately 1300 MPa to 2000 MPa. The acrylic resin described above has a high Young's modulus of approximately 1650 MPa. Thus, the restriction layer 3, which has an elasticity higher than that of the vibration damper 2, is resistant to bending deformation, or tensile deformation and compressive deformation.

The restriction layer 3 fits at least in the recessed part 12. Thus, the restriction layer 3 fitting in the recessed part 12 can restrict the protruding parts 11 on both sides of the recessed part 12.

In the embodiment, as shown in FIG. 1, the restriction layer 3 covers the protruding parts 11 and the recessed parts 12 of the vibration damper 2 entirely.

### Description of Mechanism of Vibration Damping by Vibration Damping Structure

Hereinafter, a mechanism of vibration damping by the vibration damping structure according to the embodiment will be described.

First, a mechanism of increase in the strain energy in the vibration damper 2 by the restriction layer 3 in the vibration damping structure according to the embodiment will be described.

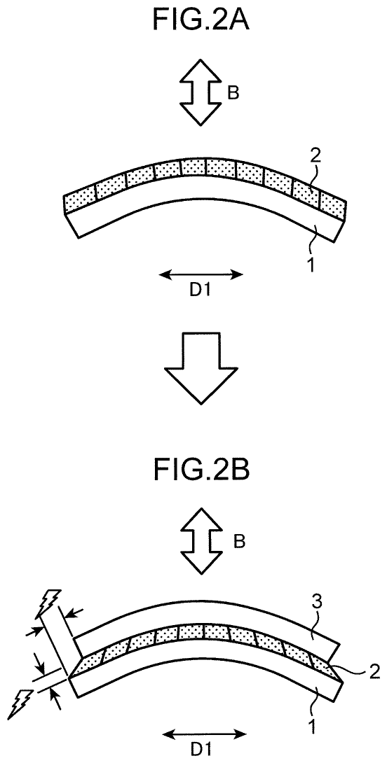

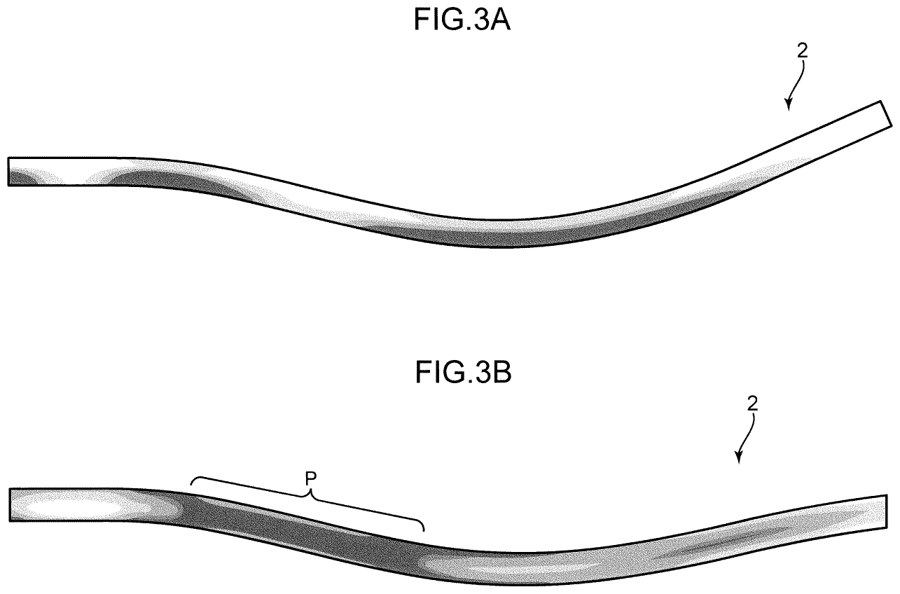

In a structure as a comparative example shown in FIG. 2A in which only the vibration damper 2 is layered on the panel member 1, when the vibration damper 2 is stretched in the first direction D1 in response to application of the bending load B to the panel member 1, the vibration damper 2 is entirely stretched and deformed in accordance with the panel member 1. Therefore, it is considered that the vibration damper 2 stores low strain energy. FIG. 3A indicating distribution of the strain energy stored in the vibration damper 2 in FIG. 2A shows that there are few dark-colored parts representing regions with high strain energy. This means that the vibration damper 2 stores low strain energy.

On the other hand, as shown in FIG. 2B, in a structure representing the embodiment in which the vibration damper 2 and the restriction layer 3 are layered on the panel member 1, the restriction layer 3 restricts the vibration damper 2 to prevent the vibration damper 2 from being stretched and deformed in the first direction D1, so that shear deformation, i.e., large deformation in a shear direction can be caused at opposite ends of the vibration damper 2. This enables the vibration damper 2 to store high strain energy. FIG. 3B indicating distribution of the strain energy stored in the vibration damper 2 in FIG. 2B shows that there are more dark-colored parts representing regions with high strain energy, including a part P that is very dark particularly, than FIG. 3A. This means that the vibration damper 2 stores high strain energy.

As shown in FIG. 1, in the vibration damping structure according to the embodiment, each of the protruding parts 11 of the vibration damper 2 is continuous in the first direction D1 being the direction in which the vibration damper 2 is to be stretched and deformed in response to the application of the bending load B. In this regard, with reference to FIGS. 4A and 4B schematically showing cross-sections of the vibration damper 2 and the restriction layer 3, no strain energy is stored in the vibration damper 2 in a state before vibration in FIG. 4A, and strain energy is stored in the vibration damper 2 in a state during the vibration in FIG. 4B. Particularly, the highest strain energy E is stored at a corner 11a of a protruding part 11 and a corner 12a of a recessed part 12 of the vibration damper 2. This shows that the vibration damping structure including the protruding parts 11 restricted by the restriction layer 3 as shown in FIG. 1 exerts a strong vibration damping effect.

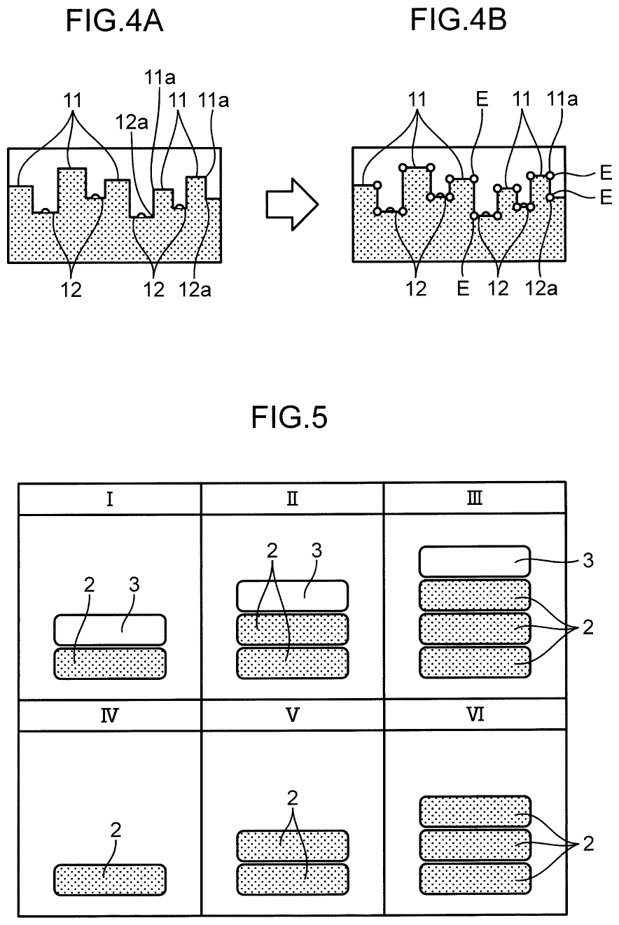

Next, the vibration damping effect by the vibration damping structure according to the embodiment will be verified with reference to FIGS. 5 to 9.

FIG. 5 is a table showing exemplary vibration damping structures for examining the vibration damping effect, where I to III represent structures as examples, which have one, two, or three layers of the vibration damper 2 and the restriction layer 3 adhered to an uppermost layer of the vibration damper 2, and IV to VI represent structures as comparative examples, which have one, two, or three layers of the vibration damper 2 only without the restriction layer 3.

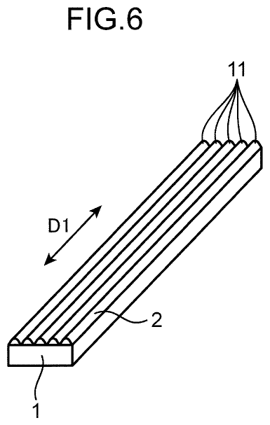

FIG. 6 is an illustration schematically showing a test sample as the example in which the vibration damper 2 is applied longitudinally on the panel member 1. Specifically, in the test sample resulting from the longitudinal application shown in FIG. 6, the vibration damper 2 is applied in the first direction D1 being the direction in which the vibration damper 2 is to be stretched or compressed in response to the application of the bending load to the panel member 1, and each of the protruding parts 11 is continuous in the first direction D1.

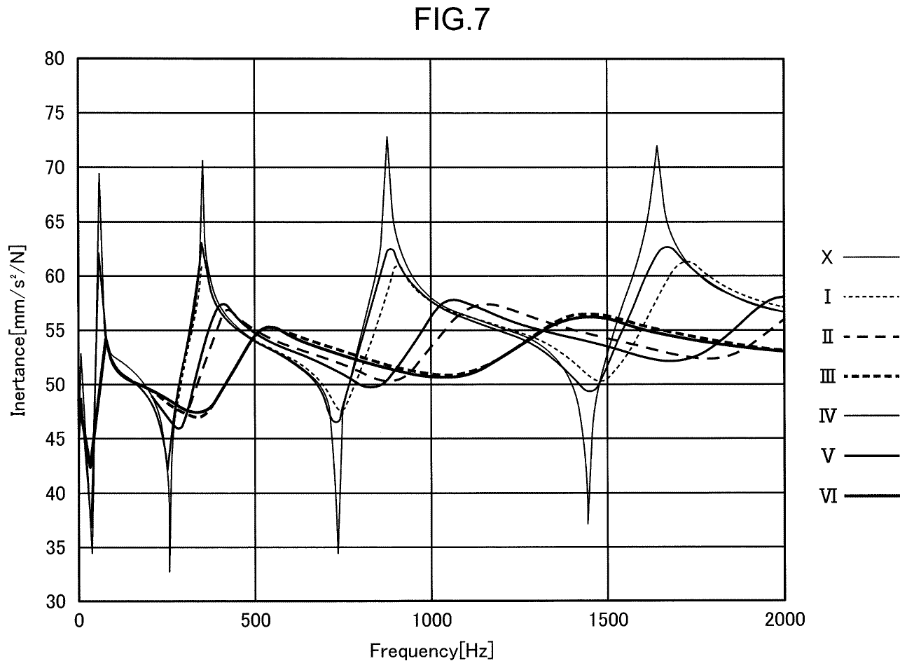

FIG. 7 is a graph showing a relationship between inertances (ratio of acceleration to force applied to an object) and frequencies of vibration waves due to vibration to vibration damping structures in which the test sample as the example in FIG. 6 is combined with the structures I to VI in FIG. 5, and vibration to a structure X including the panel member 1 only.

The graph in FIG. 7 for a case where the vibration damper 2 is applied longitudinally on the panel member 1 shows that each of curves I to III indicative of inertances of structures as the examples in which one, two, or three layers of the vibration damper 2 and the restriction layer 3 are adhered and curves IV to VI indicative of inertances of structures as the comparative examples including one, two, or three layers of the vibration damper 2 only has a gentler peak than a curve X (the thinnest curve among the curves in FIG. 7) indicative of the inertance of the structure including the panel member 1 only, resulting in a stronger effect of reducing the peak of the inertance.

The graph in FIG. 7 also shows that the peaks of the curves I to III indicative of the inertances of the structures as the examples including the vibration damper 2 and the restriction layer 3 are apparently lower than the peaks of the curves IV to VI indicative of the inertances of the structures as the comparative examples including the vibration damper 2 only without the restriction layer 3, which indicates that the restriction layer 3 greatly contributes to the enhancement of the vibration damping effect.

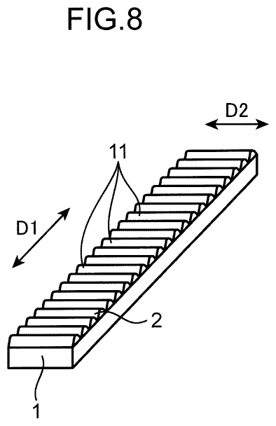

The vibration damping effect by a structure as a comparative example in which the vibration damper 2 is applied laterally on the panel member 1 as shown in FIG. 8 will be verified. In a test sample resulting from the lateral application shown in FIG. 8, the vibration damper 2 is applied in a second direction D2 orthogonal to the first direction D1 in which the vibration damper 2 is to be stretched or compressed in response to the application of the bending load to the panel member 1, and each of the protruding parts 11 is continuous in the second direction D2.

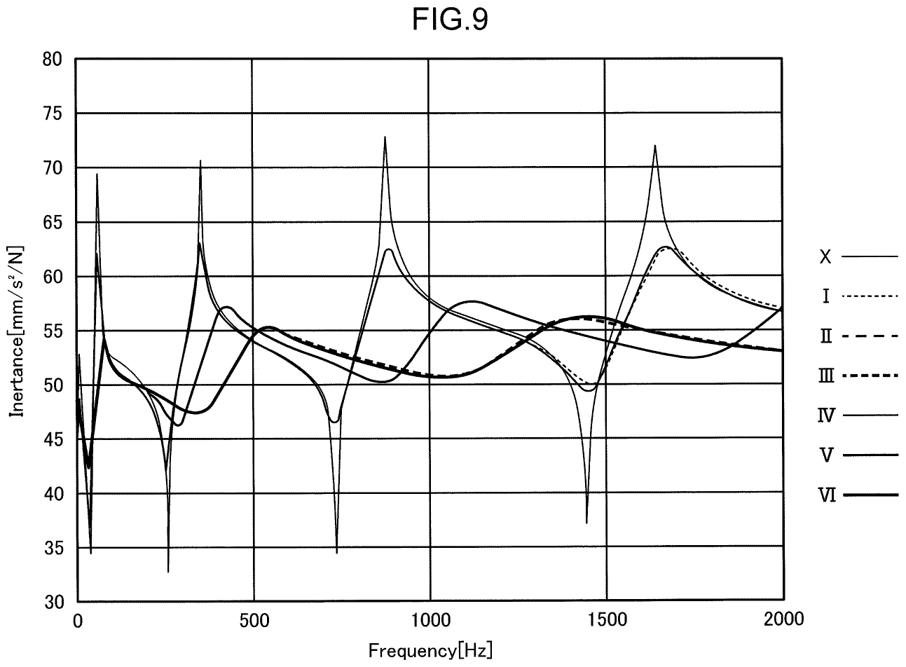

FIG. 9 is a graph showing a relationship between inertances and frequencies of vibration waves due to vibration to vibration damping structures in which the test sample as the comparative example in FIG. 8 is combined with the structures I to VI in FIG. 5 and vibration to the structure including the panel member 1 only (for its inertance, see a curve X in FIG. 9).

The graph in FIG. 9 for a case where the vibration damper 2 is applied laterally on the panel member 1 shows that each of curves I to III indicative of inertances of structures as the examples in which one, two, or three layers of the vibration damper 2 and the restriction layer 3 are adhered and curves IV to VI indicative of inertances of structures as the comparative examples including one, two, or three layers of the vibration damper 2 only does not have a very gentle peak, resulting in a weaker effect of reducing the peak of the inertance in comparison with the examples of the longitudinal application in the graph of FIG. 7. The graph in FIG. 9 also shows that the peaks of the curves I to III indicative of the inertances of the structures including the restriction layer 3 are not much lower than the peaks of the curves IV to VI indicative of the inertances of the structures as the comparative examples without the restriction layer 3, which indicates that the restriction layer 3 feebly contributes to the vibration damping effect.

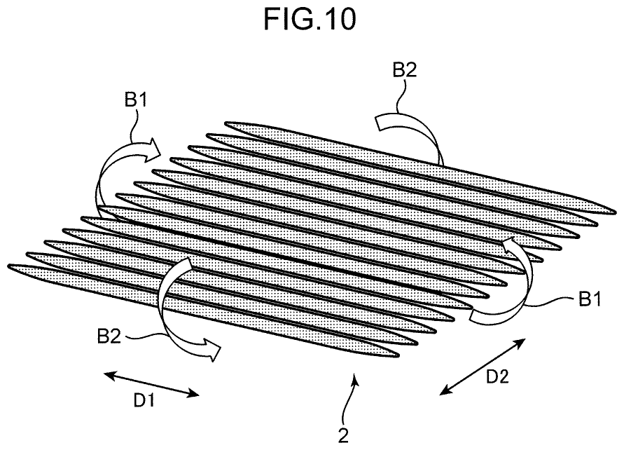

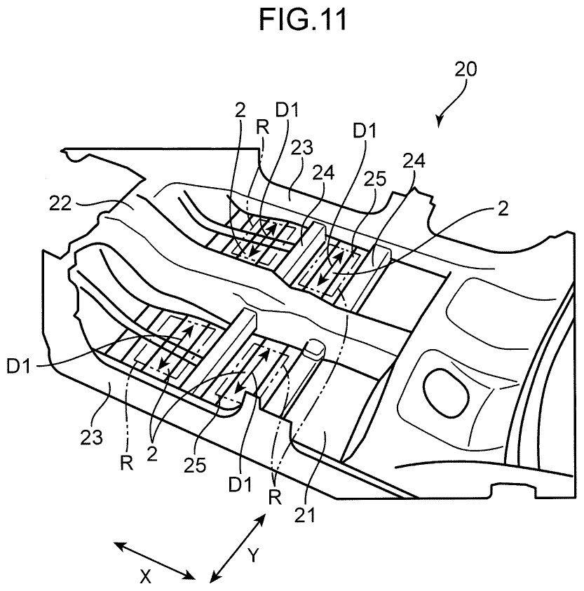

A comparison between the graphs in FIGS. 7 and 9, which indicates that the peaks of the inertances of the curves I to III in FIG. 7 are much lower than the peaks of the curves I to III in FIG. 9, shows that the vibration damping effect of the test sample as the example shown in FIG. 6 in which the vibration damper 2 is applied longitudinally on the panel member 1 is stronger than that of the test sample as the comparative example of the lateral application shown in FIG. 8. With reference to FIG. 10, the vibration damping effects of the longitudinally applied vibration damper 2 and the laterally applied vibration damper 2 will be further compared. A schematic model as shown in FIG. 10 indicates that the vibration damper 2 applied longitudinally with respect to a bending direction B1, i.e., the vibration damper 2 along the first direction D1 has a higher flexural rigidity in the bending direction B1, and has a stronger vibration damping effect. On the other hand, for a structure in which the vibration damper 2 is applied laterally with respect to a bending direction B2 (i.e., a structure in which the vibration damper 2 is applied in the first direction D1 orthogonal to the second direction D2 along the bending direction B2), the model indicates that the vibration damper 2 has a lower flexural rigidity in the bending direction B2, and has a weaker vibration damping effect.

### Exemplary Adoption of Vibration Damping Structure According to Embodiment

Next, exemplary adoption of the vibration damping structure according to the embodiment will be described with reference to FIGS. 11 to 14.

As shown in FIG. 11, the vibration damping structure according to the embodiment shown in FIG. 1 can be used for damping vibration of the floor panel 21 that constitutes the floor of the vehicle. In other words, the floor panel 21 in FIG. 11 corresponds to the panel member 1 in FIG. 1. The floor panel 21 has an upper surface, on which the vibration damper 2 in FIG. 1 is applied in the vehicle width direction Y serving as the first direction D1, i.e., applied such that the first direction D1 in FIG. 1 agrees with the vehicle width direction Y in FIG. 11. Although not shown in FIG. 11, the vibration damper 2 has the protruding parts 11 extending in the first direction D1, and the restriction layer 3 covers the vibration damper 2 from above as shown in FIG. 1.

As shown in FIG. 11, a lower portion of a vehicle body 20 has a center frame 22, such as a floor tunnel, extending in the vehicle longitudinal direction X at a middle position in the vehicle width direction Y, and a pair of side frames 23, such as side sills, extending in the vehicle longitudinal direction X at opposite ends in the vehicle width direction Y.

The floor panel 21 shown in FIG. 11 has opposite ends fixed to the center frame 22 and the side frame 23 of the vehicle body that extend in the vehicle longitudinal direction X. The floor panel 21 may be fixed to at least one frame extending in the longitudinal direction. The floor panel 21 may be fixed to a frame at a part of the floor panel 21 other than ends thereof.

The vibration damper 2 is applied on and adhered to the floor panel 21 to extend in an intersection direction intersecting the vehicle longitudinal direction X, preferably, to extend in the vehicle width direction Y (first direction D1) perpendicularly intersecting the vehicle longitudinal direction X.

Additionally, each of the protruding parts 11 of the vibration damper 2 (see FIG. 1) extends continuously in the intersection direction serving as the first direction D1 in which the vibration damper 2 is to be stretched or compressed in response to the application of the bending load to the floor panel 21 having the opposite ends fixed to the frames 22, 23, preferably, extends continuously in the vehicle width direction Y.

The vibration damper 2 shown in FIG. 11 extends in the vehicle width direction Y perpendicularly intersecting the vehicle longitudinal direction X and is adhered to the floor panel 21. The protruding parts 11 shown in FIG. 1 are continuous in the vehicle width direction Y serving as the first direction D1.

The floor panel 21 is fixed to a plurality of cross members 24 of the vehicle body that extend in the vehicle width direction Y and are spaced away from each other in the vehicle longitudinal direction X.

The floor panel 21 has a region 25 between the cross members 24, the region serving as a curved part that is curved downward.

The vibration damper 2 is adhered by, e.g., application to at least a part of, preferably, an entire of an inward portion of the region 25 serving as the curved part. Thus, the vibration damper 2 restricted by the restriction layer 3 as shown in FIG. 1 can effectively damp vibration in the region 25 of the floor panel 21 that is curved downward and has a low flexural rigidity. The curved part may be curved either upward or downward.

For more effective vibration damping, preferably, the vibration damper 2 extends in the region 25 between the cross members 24 in the vehicle width direction Y, and the protruding parts 11 shown in FIG. 1 are continuous in the vehicle width direction Y serving as the first direction D1.

Preferably, the vibration damper 2 is located in a region R of the floor panel 21 below a seat such as a driver's seat, a passenger seat, and a rear seat, as shown in FIG. 11.

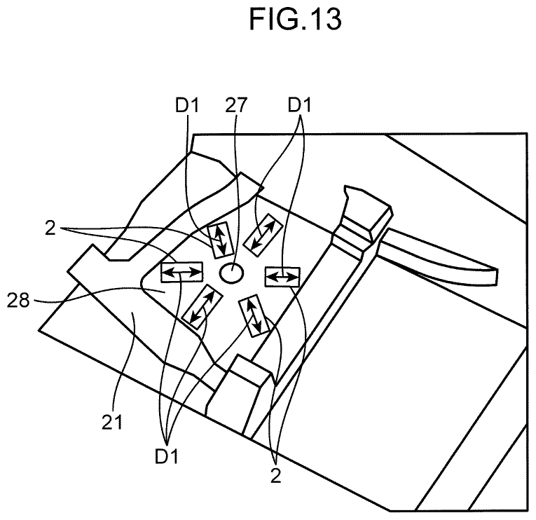

As shown in FIGS. 12 and 13, the floor panel 21 has a rear part formed with a spare tire pan 26, 28 for housing a spare tire, which is another exemplary curved part that is curved downward. The vibration damper 2 is adhered to at least a part of, preferably, an entire of an inward portion of the spare tire pan 26, 28 serving as the curved part having a low flexural rigidity, thereby enabling vibration damping in the spare tire pan 26, 28. Although not shown in FIGS. 12 and 13, the vibration damper 2 has the protruding parts 11 extending in the first direction D1, and the restriction layer 3 covers the vibration damper 2 from above as shown in FIG. 1. The curved part may be curved either upward or downward.

The spare tire pan 26, 28 curved downward has a particularly low flexural rigidity in a centrifugal direction from a center of the spare tire pan 26, 28 toward a periphery. Therefore, as shown in FIGS. 12 and 13, a plurality of the vibration dampers 2 is adhered to the spare tire pan 26, 28 serving as the curved part and spaced away from each other around the center of the spare tire pan 26, 28 so as to extend radially in the centrifugal direction (the same direction as the first direction D1 in FIGS. 12 to 14) from the center toward the periphery, in a view from an upper side being one side along an up-down direction. The protruding parts 11 are continuous in the centrifugal direction serving as the first direction D1, so that a strong vibration damping effect can be exerted.

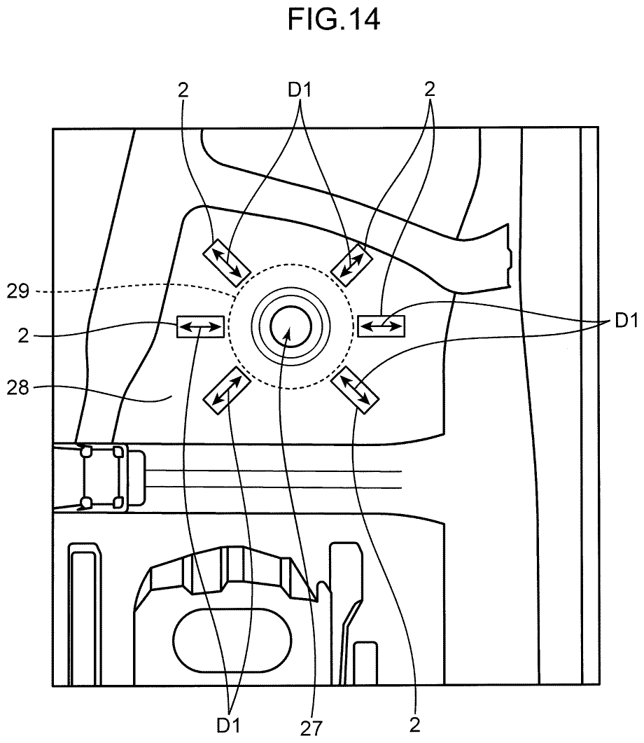

In a case where the spare tire pan 28 has an opening 27 at a center of the spare tire pan 28 as shown in FIG. 13, a plurality of the vibration dampers 2 may extend radially from a ridgeline 29 around the opening 27 as shown in the enlarged view in FIG. 14.

### Features of Embodiment

(1) As shown in FIG. 1, the vibration damping structure according to the embodiment includes the vibration damper 2 adhered to the upper surface 1a of the panel member 1 by, e.g., application, and the restriction layer 3 adhered to the upper surface 2c of the vibration damper 2.

The vibration damper 2 has the protruding parts 11 each extending continuously along the first direction D1 being a direction in which the vibration damper 2 is to be stretched or compressed in response to application of the bending load B to the panel member 1, and spaced away from each other in the second direction D2 orthogonal to the first direction D1, and the recessed parts 12 each formed between two protruding parts 11 adjacent to each other among the protruding parts 11. Thus, the protruding parts 11 increase a second area moment of the vibration damper 2, so that a flexural rigidity of the vibration damper 2 is enhanced.

Further, the restriction layer 3 fitting in a recessed part 12 of the vibration damper 2 restricts two protruding parts 11 on both sides of the recessed part 12, so that the flexural rigidity of the vibration damper 2 is further enhanced. Therefore, the vibration damper 2 stores higher strain energy in response to a shear force applied to the vibration damper 2 adhered to the panel member 1 when the bending load B is applied to the panel member 1. Thus, the vibration damping effect can be enhanced.

(2) As shown in FIG. 11, in the vibration damping structure according to the embodiment, the panel member 1 serves as the floor panel 21 that constitutes the floor of the vehicle. The floor panel 21 has the opposite ends fixed to the frames 22, 23 of the vehicle body extending in the vehicle longitudinal direction X. The vibration damper 2 extends in the intersection direction (e.g., the vehicle width direction Y in FIG. 11) intersecting the vehicle longitudinal direction X and is adhered to the floor panel 21. The protruding parts 11 extend in the intersection direction serving as the first direction D1.

In this configuration, the panel member 1 serves as the floor panel 21 that constitutes the floor of the vehicle, and the opposite ends of the floor panel 21 are fixed to the frames 22, 23 extending in the vehicle longitudinal direction X. Thus, the floor panel 21 has an enhanced flexural rigidity in the vehicle longitudinal direction X due to a reinforcing effect by the frames 22, 23.

In contrast, flexural rigidity in the intersection direction intersecting the vehicle longitudinal direction X, particularly in the vehicle width direction Y is low because the reinforcing effect by the frames 22, 23 is weak. Accordingly, the floor panel 21 is most likely to be bent and deformed in the vehicle width direction Y when receiving external vibration.

Therefore, in this configuration, the vibration damper 2 extends in a direction intersecting the vehicle longitudinal direction X and is adhered to the floor panel 21, and the protruding parts 11 are continuous in the intersection direction. Further, the protruding parts 11 that are continuous in the intersection direction are restricted by the restriction layer 3, so that the rigidity of the vibration damper 2 can be enhanced, and the vibration damper 2 can store strain energy. Consequently, the vibration damping effect can be enhanced.

(3) In the vibration damping structure according to the embodiment, the vibration damper 2 extends in the vehicle width direction Y orthogonal to the vehicle longitudinal direction X and is adhered to the floor panel 21. The protruding parts 11 extend in the vehicle width direction Y serving as the first direction D1.

In this configuration, the vibration damper 2 extends in the vehicle width direction Y for which the flexural rigidity of the floor panel 21 is the lowest, and the protruding parts 11 are continuous in the vehicle width direction Y, so that the vibration damper 2 can store higher strain energy. Consequently, the vibration damping effect can be further enhanced.

(4) In the vibration damping structure according to the embodiment, the floor panel 21 has the spare tire pan 26, 28 that is curved downward as shown in FIGS. 12 to 14, which represents the curved part that is curved downward or upward. The vibration damper 2 is adhered to the spare tire pan 26, 28.

In a case where the floor panel 21 has the curved part such as the spare tire pan 26, 28, the curved part has a lower flexural rigidity than a flat part of the floor panel 21, particularly, has a much lower flexural rigidity than a flat part reinforced by the frames 22, 23. Therefore, in the configuration described above, the vibration damper 2 is adhered to the curved part (spare tire pan 26, 28) of the floor panel 21 with a lower flexural rigidity. Thus, the vibration damper 2 having an enhanced rigidity due to the restriction of the protruding parts 11 by the restriction layer 3 as described above can store the strain energy. Consequently, the vibration damping effect can be enhanced.

(5) In the vibration damping structure according to the embodiment, as shown in FIGS. 12 to 14, a plurality of the vibration dampers 2 is adhered to the spare tire pan 26, 28 serving as the curved part and spaced away from each other around the center of the spare tire pan 26, 28 so as to extend radially in the centrifugal direction (the same direction as the first direction D1 in FIGS. 12 to 14) from the center toward the periphery, in a view from one side along the up-down direction, e.g., from an upper side. The protruding parts 11 extend in the centrifugal direction serving as the first direction D1.

The spare tire pan 26, 28 has a particularly low flexural rigidity in a direction from the center thereof toward the periphery; however, the configuration as described above enables the vibration damper 2 to store higher strain energy. Consequently, the vibration damping effect can be further enhanced.

(6) In the vibration damping structure according to the embodiment, the curved part includes the spare tire pan 26, 28 for housing the spare tire. In this configuration, the spare tire pan 26, 28 having a diameter large enough to house the spare tire serves as the curved part. The spare tire pan 26, 28 has a particularly lower flexural rigidity than other parts of the floor panel 21; therefore, the vibration damper 2 is adhered to the spare tire pan 26, 28, so that the vibration damper 2 can store the strain energy. Consequently, the vibration damping effect in the spare tire pan 26, 28 can be enhanced.

(7) As shown in FIG. 11, in the vibration damping structure according to the embodiment, the floor panel 21 is fixed to the cross members 24 of the vehicle body that extend in the vehicle width direction Y and are spaced away from each other in the vehicle longitudinal direction X.

The curved part is in the region 25 of the floor panel 21 between the cross members 24.

The region 25 of the floor panel 21 between the cross members 24, corresponding to the curved part, has a particularly low flexural rigidity; therefore, in this configuration, the vibration damper 2 is adhered to the region 25, so that the vibration damper 2 can store higher strain energy. Consequently, the vibration damping effect in the region 25 of the floor panel 21 between the cross members 24 can be enhanced.

(8) In the vibration damping structure according to the embodiment, the vibration damper 2 extends in the region 25 between the cross members 24 in the vehicle width direction Y. The protruding parts 11 extend in the vehicle width direction Y serving as the first direction D1. The region 25 between the cross members 24 has a particularly low flexural rigidity in the vehicle width direction Y; therefore, in this configuration, the vibration damper 2 extends in the vehicle width direction Y and is adhered to the region 25, and the protruding parts 11 of the vibration damper 2 are continuous in the vehicle width direction Y. Thus, the vibration damper 2 can store still higher strain energy. Consequently, the vibration damping effect in the region 25 between the cross members 24 can be further enhanced.

(9) In the vibration damping structure according to the embodiment, the restriction layer 3 is made of clear coating material. This configuration enables conventional vehicle manufacturing equipment that performs clear coating to create the vibration damping structure described above.

(10) In the vibration damping structure according to the embodiment, the vibration damper 2 is located in the region R of the floor panel 21 below a seat. An occupant easily perceives vibration occurring in the region R of the floor panel 21 below the seat; therefore, in this configuration, the vibration damper 2 is located in the region R, so that the occupant is less likely to perceive the vibration of the floor panel 21; thus, comfortability is improved.

(11) In the vibration damping structure according to the embodiment, the restriction layer 3 covers the protruding parts 11 and the recessed parts 12 of the vibration damper 2 entirely. Accordingly, the restriction layer 3 can integrally and firmly restrict the protruding parts 11, so that the flexural rigidity of the vibration damper 2 is further enhanced. Therefore, the vibration damper 2 stores still higher strain energy, and the vibration damping effect can be further enhanced.

### SUMMARY

The vibration damping structure described above in relation to the embodiment mainly includes the following features.

A vibration damping structure according to the embodiment described above includes: a panel member; a vibration damper adhered to at least one surface of the panel member; and a restriction layer that is adhered to a surface of the opposite side of the vibration damper from the panel member, and is less deformable than the vibration damper. The vibration damper has a plurality of protruding parts each extending continuously along a first direction being a direction in which the vibration damper is to be stretched or compressed in response to application of a bending load to the panel member, and spaced away from each other in a second direction orthogonal to the first direction, and a plurality of recessed parts each formed between two protruding parts adjacent to each other among the protruding parts. The restriction layer fits in the recessed parts.

In this configuration, the vibration damper has a plurality of protruding parts. The protruding parts each extend continuously along a first direction being a direction in which the vibration damper is to be stretched or compressed in response to application of a bending load to the panel member, and are spaced away from each other in a second direction orthogonal to the first direction. Thus, the protruding parts increase a second area moment of the vibration damper, so that flexural rigidity of the vibration damper is enhanced. Further, the restriction layer fitting in a recessed part of the vibration damper restricts two protruding parts on both sides of the recessed part, so that the flexural rigidity of the vibration damper is further enhanced. Therefore, the vibration damper stores higher strain energy in response to a shear force applied to the vibration damper adhered to the panel member when the bending load is applied to the panel member. Thus, the vibration damping effect can be enhanced.

In the vibration damping structure above, preferably, the panel member includes a floor panel that constitutes a floor of a vehicle, the floor panel is fixed to a frame of a vehicle body, the frame extending in a vehicle longitudinal direction, the vibration damper extends in an intersection direction intersecting the vehicle longitudinal direction and is adhered to the floor panel, and the protruding parts extend in the intersection direction serving as the first direction.

In this configuration, the panel member includes the floor panel that constitutes the floor of the vehicle, and the floor panel is fixed to the frame extending in the vehicle longitudinal direction. Thus, the floor panel has an enhanced flexural rigidity in the vehicle longitudinal direction due to a reinforcing effect by the frame. In contrast, flexural rigidity in the intersection direction intersecting the vehicle longitudinal direction, particularly in the vehicle width direction is low because the reinforcing effect by the frame is weak. Accordingly, the floor panel is most likely to be bent and deformed in the vehicle width direction when receiving external vibration. Therefore, in this configuration, the vibration damper extends in the intersection direction intersecting the vehicle longitudinal direction and is adhered to the floor panel, and the protruding parts are continuous in the intersection direction. Further, the protruding parts that are continuous in the intersection direction are restricted by the restriction layer, so that the rigidity of the vibration damper can be enhanced, and the vibration damper can store strain energy. Consequently, the vibration damping effect can be enhanced.

In the vibration damping structure above, preferably, the vibration damper extends in a vehicle width direction perpendicularly intersecting the vehicle longitudinal direction and is adhered to the floor panel, and the protruding parts extend in the vehicle width direction serving as the first direction.

In this configuration, the vibration damper extends in the vehicle width direction for which the flexural rigidity of the floor panel is the lowest, and the protruding parts are continuous in the vehicle width direction, so that the vibration damper can store higher strain energy. Consequently, the vibration damping effect can be further enhanced.

In the vibration damping structure above, preferably, the panel member includes a floor panel that constitutes a floor of a vehicle, the floor panel has a curved part that is curved downward or upward, and the vibration damper is adhered to the curved part.

In a case where the floor panel has a curved part protruding downward or upward, the curved part has a lower flexural rigidity than a flat part of the floor panel. Therefore, in the configuration above, the vibration damper is adhered to the curved part of the floor panel with a lower flexural rigidity. Thus, the vibration damper having an enhanced rigidity due to the restriction of the protruding parts by the restriction layer as described above can store the strain energy. Consequently, the vibration damping effect can be enhanced.

In the vibration damping structure above, preferably, a plurality of the vibration dampers is adhered to the curved part and spaced away from each other around a center of the curved part so as to extend radially in a centrifugal direction from the center, in a view from one side along an up-down direction, and the protruding parts extend in the centrifugal direction serving as the first direction.

The curved part has a particularly low flexural rigidity in a direction from the center thereof toward a periphery; however, the configuration as described above enables the vibration damper 2 to store higher strain energy. Consequently, the vibration damping effect can be further enhanced.

In the vibration damping structure above, preferably, the curved part includes a spare tire pan for housing a spare tire.

In this configuration, a spare tire pan having a diameter large enough to house a spare tire serves as the curved part. The spare tire pan has a particularly lower flexural rigidity than other parts of the floor panel. Therefore, the vibration damper is adhered to the spare tire pan, so that the vibration damper can the strain energy. Consequently, the vibration damping effect in the spare tire pan can be enhanced.

In the vibration damping structure above, preferably, the floor panel is fixed to a plurality of cross members of a vehicle body that extend in a vehicle width direction and are spaced away from each other in a vehicle longitudinal direction, and the curved part is in a region of the floor panel between the cross members.

The region of the floor panel between the cross members, corresponding to the curved part, has a particularly low flexural rigidity; therefore, in this configuration, the vibration damper is adhered to the region, so that can store higher strain energy. Consequently, the vibration damping effect in the region of the floor panel between the cross members can be enhanced.

In the vibration damping structure above, preferably, the vibration damper extends in the region between the cross members in the vehicle width direction, and the protruding parts extend in the vehicle width direction serving as the first direction.

The region between the cross members has a particularly low flexural rigidity in the vehicle width direction; therefore, in this configuration, the vibration damper extends in the vehicle width direction and is adhered to the region, and the protruding parts of the vibration damper are continuous in the vehicle width direction. Thus, the vibration damper can store still higher strain energy. Consequently, the vibration damping effect in the region between the cross members can be further enhanced.

In the vibration damping structure above, preferably, the restriction layer is made of clear coating material.

This configuration enables conventional vehicle manufacturing equipment that performs clear coating to create the vibration damping structure described above.

In the vibration damping structure above, preferably, the vibration damper is located in a region of the floor panel below a seat.

An occupant easily perceives vibration occurring in the region of the floor panel below the seat; therefore, in this configuration, the vibration damper is located in the region, so that the occupant is less likely to perceive the vibration of the floor panel; thus, comfortability is improved.

In the vibration damping structure above, preferably, the restriction layer covers the protruding parts and the recessed parts of the vibration damper entirely.

In this configuration, the restriction layer covers the protruding parts and the recessed parts of the vibration damper entirely. Accordingly, the restriction layer can integrally and firmly restrict the protruding parts, so that the flexural rigidity of the vibration damper is further enhanced. Therefore, the vibration damper stores still higher strain energy, and the vibration damping effect can be further enhanced.

The vibration damping structure according to the embodiment as described above can enhance the vibration damping effect while preventing excessive increase in the vibration damper.

This application is based on Japanese Patent application No. 2024-104299 filed in Japan Patent Office on Jun. 27, 2024, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

1. A vibration damping structure comprising:
a panel member;
a vibration damper adhered to at least one surface of the panel member; and
a restriction layer that is adhered to a surface of the opposite side of the vibration damper from the panel member, and is less deformable than the vibration damper, wherein
the vibration damper has
a plurality of protruding parts each extending continuously along a first direction being
a direction in which the vibration damper is to be stretched or compressed in response to application of a bending load to the panel member, and spaced away from each other in a second direction orthogonal to the first direction, and
a plurality of recessed parts each formed between two protruding parts adjacent to each other among the protruding parts, and
the restriction layer fits in the recessed parts.

2. The vibration damping structure according to claim 1, wherein
the panel member includes a floor panel that constitutes a floor of a vehicle,
the floor panel is fixed to a frame of a vehicle body, the frame extending in a vehicle longitudinal direction,
the vibration damper extends in an intersection direction intersecting the vehicle longitudinal direction and is adhered to the floor panel, and
the protruding parts extend in the intersection direction serving as the first direction.

3. The vibration damping structure according to claim 2, wherein
the vibration damper extends in a vehicle width direction perpendicularly intersecting the vehicle longitudinal direction and is adhered to the floor panel, and
the protruding parts extend in the vehicle width direction serving as the first direction.

4. The vibration damping structure according to claim 1, wherein
the panel member includes a floor panel that constitutes a floor of a vehicle,
the floor panel has a curved part that is curved downward or upward, and
the vibration damper is adhered to the curved part.

5. The vibration damping structure according to claim 4, wherein
a plurality of the vibration dampers is adhered to the curved part and spaced away from each other around a center of the curved part so as to extend radially in a centrifugal direction from the center, in a view from one side along an up-down direction, and
the protruding parts extend in the centrifugal direction serving as the first direction.

6. The vibration damping structure according to claim 4, wherein the curved part includes a spare tire pan for housing a spare tire.

7. The vibration damping structure according to claim 4, wherein
the floor panel is fixed to a plurality of cross members of a vehicle body that extend in a vehicle width direction and are spaced away from each other in a vehicle longitudinal direction, and
the curved part is in a region of the floor panel between the cross members.

8. The vibration damping structure according to claim 7, wherein
the vibration damper extends in the region between the cross members in the vehicle width direction, and
the protruding parts extend in the vehicle width direction serving as the first direction.

9. The vibration damping structure according to claim 1, wherein the restriction layer is made of clear coating material.

10. The vibration damping structure according to claim 1, wherein the vibration damper is located in a region of the floor panel below a seat.

11. The vibration damping structure according to claim 1, wherein the restriction layer covers the protruding parts and the recessed parts of the vibration damper entirely.
